(19) United States
(12) Patent Application Publication
(10) Pub. No.: US 2015/0254774 A1
(43) Pub. Date: Sep. 10, 2015

(54) Pricing a Forward Rate Agreement Financial Product Using a Non-Par Value

(71) Applicant: Chicago Mercantile Exchange, Inc., Chicago, IL (US)

(72) Inventors: John Nyhoff, Darien, IL (US); Frederick Sturm, Chicago, IL (US); John Labuszewski, Westmont, IL (US)

(21) Appl. No.: 14/714,872

(22) Filed: May 18, 2015

Related U.S. Application Data
(63) Continuation of application No. 13/209,076, filed on Aug. 12, 2011, now abandoned.

(51) Int. Cl. G06Q 40/04

(52) U.S. Cl. CPC G06Q 40/04

(57) ABSTRACT

Computer readable media, methods, and apparatuses may be configured for processing a yield of a first financial instrument, determining a single floating rate payment based on the yield, determining a single fixed rate payment based on a fixed interest rate, determining a present value of the single floating rate payment, determining a present value of the single fixed rate payment, and generating a quote for a forward rate agreement index financial product as a function of the present value of the single floating rate payment and the present value of the single fixed rate payment.

### CROSS-REFERENCE TO RELATED APPLICATION

This application is a continuation of U.S. patent application Ser. No. 13/209,076, titled “Pricing a Forward Rate Agreement Financial Product using a Non-Par value” and filed Aug. 12, 2011. Application Ser. No. 13/209,076, in its entirety, is incorporated by reference herein.

### BACKGROUND INFORMATION

The over-the-counter (OTC) marketplace has seen a surge in activity in Forward Rate Agreements (FRAs). FRAs represent a financial instrument with an effective duration between a beginning date (also referred to as an effective date) and an ending date (also referred to as a termination date), whereby a single fixed rate payment is exchanged for a single floating rate payment on the termination date. FRAs may be used to hedge against changes in interest rates. A first party is able to lock in a fixed interest rate attempting to protect against an interest rate increase, while a second party protects against a possible interest rate decline. At maturity of an FRA, a difference in value of a payment based on the fixed rate relative a value of a payment based on the floating rate payment is determined, and payment is made from one party to the other based on the difference. FRAs differ from interest rate swaps (“swaps”) in that payment is only made once at maturity. A swap, in contrast, typically includes multiple payments at different times over the life of the swap.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Computer readable media, methods, and apparatuses may be configured for processing a yield of a first financial instrument, determining a single floating rate payment based on the yield, determining a single fixed rate payment based on a fixed interest rate, determining a present value of the single floating rate payment, determining a present value of the single fixed rate payment, and generating a quote for a forward rate agreement index financial product as a function of the present value of the single floating rate payment and the present value of the single fixed rate payment.

In some embodiments, aspects of the example embodiments may be implemented on a computer-readable medium, for example, by storing computer-executable instructions or modules, or by utilizing computer-readable data structures. The computer readable medium may be non-transitory and/or may be a memory. In an example, one or more computer readable media may store computer-executable instructions that, when executed by at least one processor, cause at least one apparatus to perform the operations described herein.

The example embodiments described herein may also include additional elements, steps, computer-executable instructions, or computer-readable data structures. For example, one skilled in the art will recognize that the various modules described herein may be implemented using programming code (e.g., C++, C, Java, etc.) and be associated with at least one processor on a computing device that may execute the module. The programming code may include common elements of software programming, such as “for loops”, “do-while loops”, function calls, if-else syntax, “switch” syntax, and other well known elements. While programming code has not been provided for each of the various modules, one skilled in the art after review of the entirety disclosed herein will appreciate that such programming code may be authored without requiring undue experimentation.

Numerous embodiments are disclosed and claimed herein. The details of these and other embodiments are set forth in the accompanying drawings and the description below. Other features and advantages will be apparent from the description and drawings, and from the claims.

### BRIEF DESCRIPTION OF THE DRAWINGS

Aspects of the disclosure may take physical form in certain parts and steps, embodiments of which will be described in detail in the following description and illustrated in the accompanying drawings that form a part hereof, wherein:

FIG. 1 depicts an illustrative operating environment that may be used to implement various aspects of the disclosure.

FIG. 2A illustrates a table including example market data corresponding to a 3-month Eurodollar FRA index futures contract having a 1% coupon and $1 million notional value in accordance with example embodiments.

FIG. 2B illustrates a table for determining the value of a quote for a FRA index futures contract in accordance with example embodiments.

FIG. 3A illustrates a table including example market data corresponding to a 1-year Eurodollar FRA Index futures contract having a 1% coupon and $1 million notional value in accordance with example embodiments.

FIG. 3B illustrates a table for determining the value of a quote for a FRA index futures contract in accordance with example embodiments.

FIG. 4 illustrates example standardized terms of 3-month, 6-month, 9-month, and 1-year Eurodollar FRA index futures contracts in accordance with example embodiments.

FIG. 5 illustrates an example flow diagram of a method for generating a quote for an FRA index financial product.

FIG. 6 illustrates an example flow diagram of a method for generating a quote for an FRA index financial product.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

The present disclosure generally relates to systems and methods that are utilized in connection with the electronic trading of forward rate agreements (FRAs). In an example, Chicago Mercantile Exchange (CME) Eurodollar futures may be used for FRAs tied to a British Bankers Association (BBA) LIBOR fixing rate. BBA LIBOR fixings may represent the benchmark against which CME Eurodollar futures are pegged. Many FRAs traded in over-the-counter (OTC) markets use the BBA LIBOR fixing as a reference rate for the transaction. Sometimes those FRAs may be constructed to settle on the same dates as standard CME Eurodollar futures (e.g., on the International Monetary Market [IMM] dates).

Eurodollar futures, however, do not convey the “convexity” associated with an OTC FRA instrument. Convexity refers to a non-linear relationship between price and yield of a zero coupon and fixed coupon interest rate instruments. Eurodollar futures, for instance, may be quoted as 100-Yield based upon a fixed $1 million face value and 90-day term. Mathematically, there is a linear relationship between the quoted price and yield associated with Eurodollar futures. In FRAs, however, there is a “convex” or non-linear relationship between the quoted yield on an FRA (or the coupon associated with the fixed rate payment) and a non-par value of the FRA. Because of this “mismatch” in convexity characteristics, CME Eurodollar futures do not perfectly track the value of an OTC FRA and, therefore, may be a reasonable but less than perfect risk management vehicle.

To provide for improved risk management, the example embodiments provide an index-based futures contract that uses Eurodollar futures prices as the basis for the floating rate payment. A fixed rate payment may be calculated on the basis of an (arbitrary) fixed coupon. The index-based financial product may be quoted in terms of 100% of par+“Non-Par” value—or the present value of the floating less the present value of the fixed rate payment, as described below in further detail.

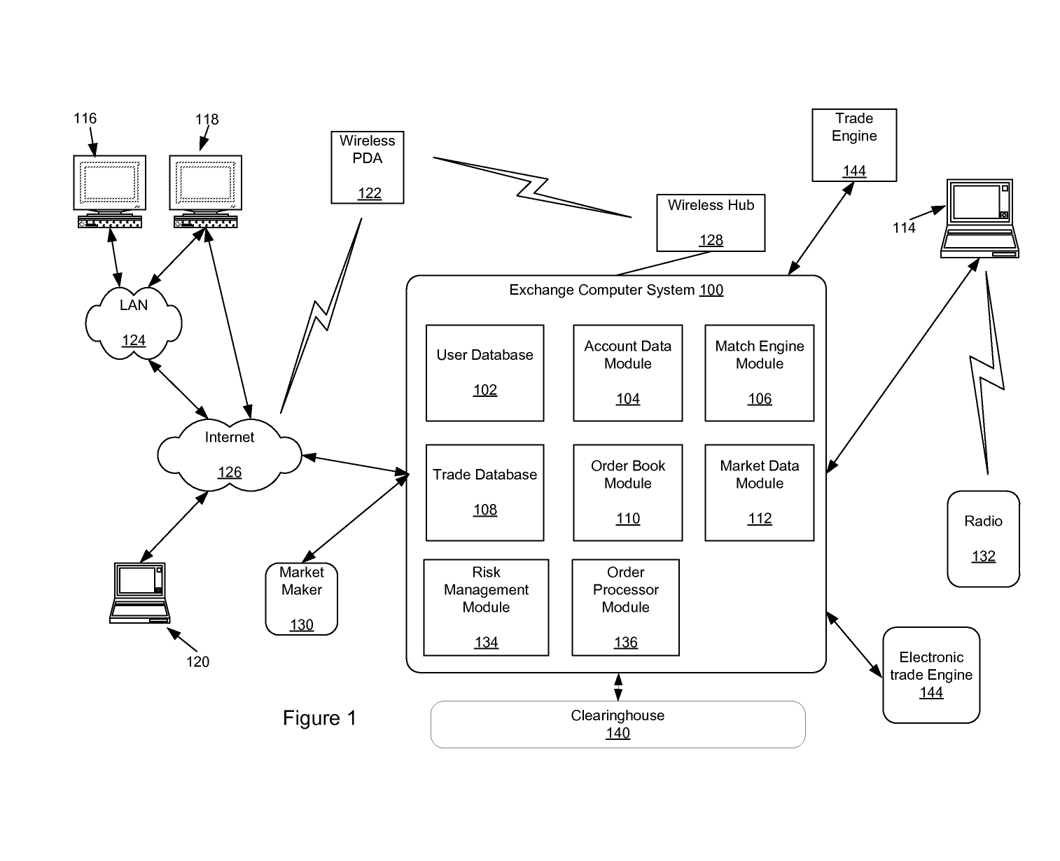

FIG. 1 depicts an illustrative operating environment that may be used to implement various aspects of the disclosure. The operating environment is only one example of a suitable operating environment and is not intended to suggest any limitation as to the scope of use or functionality of the disclosure. Aspects of the present disclosure are implemented with computing devices and networks for exchanging, transmitting communicating, administering, managing and facilitating trading information. An exchange computer system 100 may receive market data, analyze historical data, and/or calculate various values, in accordance with aspects of the disclosure.

Exchange computer system 100 may be implemented with one or more mainframes, servers, gateways, controllers, desktops or other computers. The exchange computer system 100 may include one or more modules, processors, databases, mainframes, desktops, notebooks, tablet PCs, handhelds, personal digital assistants, smartphones, gateways, and/or other components, such as those illustrated in FIG. 1. Moreover, exchange computer system 100 may include one or more processors (e.g., Intel® microprocessor, AMD® microprocessor, RISC processor, a 64-bit processor, etc.) and one or more memories (e.g., solid state, DRAM, SRAM, ROM, Flash, non-volatile memory, hard drive, registers, buffers, etc.)

In addition, an electronic trade engine 144, such as the Globex® trading system, may be associated with an exchange computer system 100. In such an embodiment, the electronic trade engine 144 may include a combination of globally distributed computers, controllers, servers, networks, gateways, routers, databases, memory, and other electronic data processing and routing devices. One skilled in the art will appreciate that numerous additional computers and systems may be coupled (i.e., in operative communication) to exchange computer system 100. Such computers and systems may include clearing, regulatory and fee systems, such as clearinghouse 140. The electronic trade engine 144 may include a trading system interface having devices configured to route incoming messages to an appropriate devices associated with the trading system. The trading system interface may include computers, controllers, networks, gateways, routers and other electronic data processing and routing devices. Orders that are placed with or submitted to the trading system are received at the trading system interface. The trading system interface may route the order to an appropriate device. An exchange computer system 100 may receive orders and transmit market data related to orders and trades to users. In another example, the trade engine 144 may be configured to process orders for instruments associated with another exchange or third party electronic trade matching system.

A user database 102 may include information identifying traders and other users of exchange computer system 100. Such information may include user names and passwords. A trader operating an electronic device (e.g., computer devices 114, 116, 118, 120 and 122) interacting with the exchange computer system 100 may be authenticated against user names and passwords stored in the user database 102. Furthermore, an account data module 104 may process account information that may be used during trades. The account information may be specific to the particular trader (or user) of an electronic device interacting with the exchange computer system 100.

A match engine module 106 may match bid and offer prices for orders configured in accordance with aspects of the disclosure. Match engine module 106 may be implemented with software that executes one or more algorithms for matching bids and offers for financial instruments in accordance with aspects of the disclosure. The match engine module 106 and trading system interface may be separate and distinct modules or component or may be unitary parts. Match engine module 106 may be configured to match orders submitted to the trading system. The match engine module 106 may match orders according to currently known or later developed trade matching practices and processes. In an embodiment, bids and orders are matched on price, on a first in, first out (FIFO) basis. The matching algorithm also may match orders on a pro-rata basis or combination of FIFO and pro rata basis. Other processes and/or matching processes may also be employed. The match engine module 106, after executing matching trades, may also report on the last price for a financial instrument.

Moreover, a trade database 108 may be included to store historical information identifying trades and descriptions of trades. In particular, a trade database may store information identifying or associated with the time that an order was executed and the contract price. The trade database 108 may also comprise a storage device configured to store at least part of the orders submitted by electronic devices operated by traders (and/or other users). A confirmation message may be sent when the match engine module 106 finds a match for an order and the order is subsequently executed. The confirmation message may, in some embodiments, be an e-mail message to a trader, an electronic notification in one of various formats, or any other form of generating a notification of an order execution.

Furthermore, an order book module 110 may be included to compute or otherwise determine current bid and offer prices. The order book module 110 may be configured to calculate the price of a financial instrument. Also, a market data module 112 may be included to collect market data and prepare the data for transmission to users. In addition, a risk management module 134 may be included in the exchange computer system 100 to compute and determine the amount of risk associated with a financial product or portfolio of financial products. An order processor module 136 may be included to receive data associated with an order for a financial instrument. The module 136 may decompose delta based and bulk order types for processing by order book module 110 and match engine module 106. The order processor module 136 may be configured to process the data associated with the orders for financial instruments.

The trading network environment shown in FIG. 1 includes computer (i.e., electronic) devices 114, 116, 118, 120 and 122. The computer devices 114, 116, 118, 120 and 122 may include one or more processors, or controllers, that control the overall operation of the computer. The computer devices 114, 116, 118, 120 and 122 may include one or more system buses that connect the processor to one or more components, such as a network card or modem. The computer devices 114, 116, 118, 120 and 122 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet pc and like computing devices having a user interface. The electronic device may be a dedicated function device such as personal communications device, a portable or desktop telephone, a personal digital assistant (“PDA”), remote control device, personal digital media system and similar electronic devices.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a local area network (LAN) 124. LAN 124 may have one or more of the well-known LAN topologies and may use a variety of different protocols, such as Ethernet. Computer devices 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

The operations of computer devices and systems shown in FIG. 1 may be controlled by computer-executable instructions stored on computer-readable storage medium (e.g., a memory, a CD, a DVD, etc.). Embodiments also may take the form of electronic hardware, computer software, firmware, including object and/or source code, and/or combinations thereof. Embodiments may be stored on computer-readable media installed on, deployed by, resident on, invoked by and/or used by one or more data processors (e.g., 64-bit processor), controllers, computers, clients, servers, gateways, networks of computers, and/or any combinations thereof. The computers, servers, gateways, may have one or more controllers configured to execute instructions embodied as computer software. For example, computer device 114 may include computer-executable instructions for receiving information from exchange computer system 100 to cause display of the information to the user.

One or more market makers 130 may maintain a market by providing bid and offer prices for a derivative or security to exchange computer system 100. Exchange computer system 100 may also exchange information with other trade engines, such as trade engine 144.

A clearinghouse 140 enables an exchange computer system 100 to provide contracts with a lower likelihood of default than over-the-counter (OTC) products. A clearinghouse 140 arranges for transactions to be settled and cleared. Clearing is the procedure through which a clearinghouse 140 becomes buyer to each seller of a contract (e.g., futures contract, equities, currencies, interest rate products, etc.), and seller to each buyer, and assumes responsibility for protecting buyer and seller from financial loss by assuring performance on each contract. A clearinghouse 140 may settle trading accounts, clear trades, collect and maintain performance bond funds, regulate delivery and report trading data. In some scenarios an exchange may operate its own clearinghouse 140 through a division of the exchange through which all trades made are confirmed, matched, and settled each day until offset or delivered. Alternatively, one or more other companies may be provided the responsibility of acting as a clearinghouse 140 with the exchange (and possibly other exchanges). An exchange may have one or more clearinghouses associated with the exchange. An exchange may offer firms qualified to clear trades to provide a clearinghouse 140 for the exchange computer system 100. In some instances, these clearing members may be designated into different categories based on the type of commodities they can clear and other factors.

The clearinghouse 140 may establish minimum performance bond (i.e., initial margin) requirements for the products it handles. A customer may be required to deposit a performance bond with the clearinghouse 140 (or designated account) for the purpose of insuring the clearinghouse 140 against loss on open positions. The performance bond helps ensure the financial integrity of brokers, clearinghouses, and exchanges as a whole. If a trader experiences a drop in funds below a designated minimum requirement (e.g., the maintenance margin level), the clearinghouse 140 may issue a margin call requiring a deposit into the margin account to restore the trader's equity. A clearinghouse 140 may charge additional performance bond requirements at the clearinghouse's discretion. For example, if a clearinghouse's potential market exposure grows large relative to the financial resources available to support those exposures, the clearinghouse 140 may issue a margin call.

In another embodiment, the clearinghouse 140 may require a larger performance bond based on a credit check (e.g., an analysis of the credit worthiness, such as using a FICO™ or comparable score, inter alia) of the customer/trader. The credit check may be performed (i.e., initiated) by a computer of the clearinghouse 140 or the exchange computer system 100. In the example where the clearinghouse 140 performs the credit check, the clearinghouse 140 may send a message (e.g., enforcement message) to the exchange computer system 100. If the credit check indicates that a customer/trader is a high risk, the enforcement message may increase the margin requirements of the customer/trader, or otherwise adjust the capabilities/constraints of the customer/trader commensurate with the higher risk. In the example where the exchange computer system 100 initiates the credit check, the exchange computer system 100 may send a message to one or more clearinghouses associated with the exchange computer system 100 to update them on the increased/decreased risk associated with the customer/trader.

In recognition of the desire to promote efficient clearing procedures and to focus on the true intermarket risk exposure of clearinghouses, a cross-margining system may be used. By combining the positions of joint and affiliated clearinghouses in certain broad-based equity index futures and options into a single portfolio, a single performance bond requirement across all markets may be determined. The cross-margining system may greatly enhance the efficiency and financial integrity of the clearing system.

The principal means by which a clearinghouse 140 mitigates the likelihood of default is through mark-to-market (MTM) adjustments. The clearinghouse 140 derives its financial stability in large part by removing debt obligations among market participants as they occur. Through daily MTM adjustments, every contract is debited or credited based on that trading session's gains or losses. For example, as prices move for or against a position, funds flow into or out of the trading account. This cash flow is known as settlement variation or variation margin.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Example Embodiments

The example embodiments discussed herein provide for a Forward Rate Agreement (FRA) index financial product such as, for example, an FRA index futures contract. The example embodiments describe an FRA index futures contract that is created by indexing an FRA to a sufficiently liquid financial instrument, such as, for example, a Eurodollar futures contract. The FRA index futures contract may be cash settled at the end of a predetermined time interval (e.g., on a quarterly basis).

The FRA index futures contract may have standardized terms with the only trading variable being priced to permit automated trading on an exchange, thus avoiding having to individually assess terms of the FRA index futures contracts. Traders may submit buy and sell orders for the FRA index futures contracts for matching by an exchange computer system 100 or by a computer of another market marker.

In an example embodiment, the FRA index futures contract may be a futures contract based on an FRA associated with a single fixed rate payment established at a particular coupon (e.g., 1%, 2% on an annual basis) and a single floating rate payment referenced to a sufficiently liquid financial instrument (e.g., Eurodollar futures contract referenced to a 3 month BBA LIBOR rate). The fixed rate coupon may also be referred to as an interest rate.

In an example, the FRA index futures contract may have a notional value (e.g., $1,000,000) at a particular coupon (e.g., 1%) that is fixed over a predetermined term (e.g., 3 months, 6 months, 9 months, 1 year, etc.). The notional value may be of any desired amount, and the term of the FRA index futures contract may be of any desired time duration. In an example, FRA index futures could include have a duration of six months to ten years corresponding with the maturities of CME Eurodollar futures contracts. As such, this could enable contract position holders to “auto-roll” from a contract with a notional tenor of N quarters to a contract with a notional tenor of N−1 quarters).

FRA Index futures contracts may be, for example, offered for final cash settlement on a quarterly basis (e.g., on the 1st Monday preceding the 3rd Wednesday of the contract months of March, June, September and December) and may correspond with the normal expiration cycle of CME Eurodollar futures contracts (or other futures contracts).

The exchange computer system 100 may calculate the fixed rate payment based upon multiplying the notional value by the fixed coupon, and adjusting for time duration. For example, if a coupon is fixed at 1% annual percentage rate over a 6-month time period, then a fixed payment would be $5,000 (i.e., $1,000,000*0.01*0.5).

The floating rate payment may be based on a sufficiently liquid financial instrument such as, for example, a Eurodollar futures contract. A Eurodollar futures contract may have a maturity date anywhere from one day to 10 years. Each Eurodollar futures contract may have an implied yield based on a particular maturity date, and each implied yield may vary over time. Short term interest rates (or yields) tied to other types of financial instruments may also be used, including, for example, U.S. Treasury bill rates, Eurodollar rates (i.e., spot rates rather than the implied rates derived from a Eurodollar futures price), Euribor rates, Euro-Sterling rates, Euroyen rates, EuroSwiss rates, commercial paper rates, banker acceptance rates, the U.S. prime rate, etc. Generally, any financial instrument having a yield for different future time horizons may be used. The exchange computer system 100 may calculate the floating rate payment by reference to settlement values and corresponding yields of the sufficiently liquid financial instrument on a final settlement date that occurs periodically (e.g., monthly, quarterly, etc.).

In an example, the floating rate payment for a 3-month Eurodollar FRA Index futures contract may be calculated by reference to the settlement value, and corresponding yield, of a single CME Eurodollar futures contract on a final settlement date of a Eurodollar FRA index futures contract. The floating payment for 6-month, 9-month or 1-year Eurodollar FRA Index futures may be calculated by reference to the compounded value of a Eurodollar futures strip. For example, the floating payment associated with a 1-year Index is determined as the compounded value of the yields on the next four (4) quarterly Eurodollar futures contracts.

The exchange computer system 100 may determine a quote for a FRA index futures contract based on the term of the FRA contract and by reference to one or more yields at predetermined times for the sufficiently liquid financial instruments over the term. The yield for the sufficiently liquid financial instruments for each of the maturity dates may be obtained from a market data source, such as, for example, CME Globex®. To determine the quote, the exchange computer system 100 may obtain market data from a market data source on current settlement prices and/or yields for the sufficiently liquid financial instrument, where each of the settlement prices and/or yields correspond to a different maturity date.

The quote for the FRA index futures contract may reflect a present value of the single fixed payment relative to a present value of the single floating payment. To determine a present value of the fixed and floating rate payments, the exchange computer system 100 may calculate present value factors based on the reciprocal of day-count adjusted compounded returns associated with a strip of Eurodollar futures. The quote may be a function of a non-par value, which is the difference between “par value” for the FRA index futures contract (or 100% of par) and the present value (PV) of the single floating rate payment minus the PV of the single fixed rate payment. The exchange computer system 100 may determine the non-par value using the following equation:

Non Par Value=PV(Floating Rate Payment)−PV(Fixed Rate Payment) (1)

Where PV(Floating Rate Payment) is the present value of a single floating rate payment over a time period (e.g., 2 years) of the FRA index futures contract and PV(Fixed Rate Payment) is the present value of a single fixed rate payment over the time period. Using the non-par value in percent of par, the exchange computer system 100 may calculate an Index quote using the following equation:

Index Quote=100%+Non Par Value in % of Par (2)

The resulting value for the index quote, or 100 plus the non-par value, may be calculated in dollars and cents for a $1 million notional value unit and presented in terms of percent of par by dividing the non-par value (in USD) by the $1 million notional value. The index value may be quoted as 100+Non-Par Value in percent of par and presented relative to 100% of par.

When the PV of the single floating rate payment exceeds the PV of the single fixed rate payment, the Index value may be quoted in excess of 100% of par. When the PV of the floating rate payment is less than the PV of the fixed rate payment, the Index may be quoted at a value less than 100% of par.

Below are examples of how to calculate 3-month and 1-year FRA Indexes. These examples may be used for calculating indexes of other time durations.

The following is an example of determining a quote for FRA index futures contract that is configured as a FRA between a single floating rate payment and a single fixed rate payment over a 3-month term using an actual/360 day count convention and denominated in U.S. dollars (USD). Other currencies, time durations, and day count conventions may also be used.

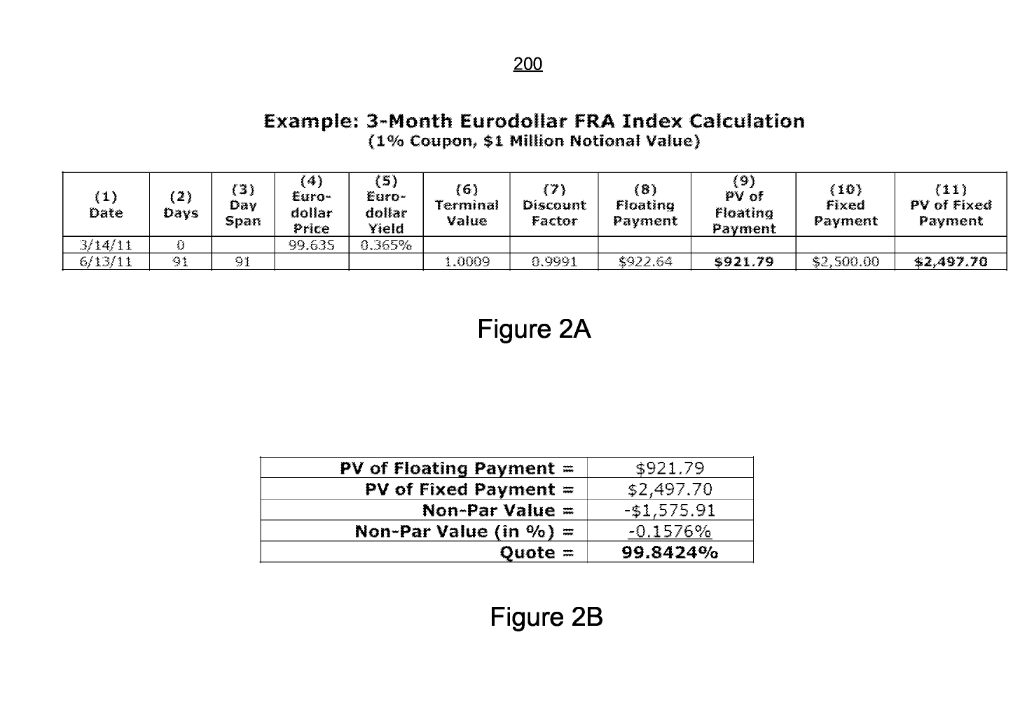

FIG. 2A illustrates a table corresponding to a 3 month Eurodollar FRA Index Calculation having a 1% coupon and $1 million Notional value. Starting on the left, column (1) of table 200 includes final settlement dates of standard quarterly Eurodollar futures contracts. The first date in this calculation of Mar. 14, 2011 represents a final settlement date for a Eurodollar FRA Index futures contract. Column (2) lists a day-count between the first date (i.e., in this case Mar. 14, 2011) and any subsequent quarterly date when a floating rate payment is made. For example, the FRA index futures contract may have standard terms specifying use of International Swaps and Derivatives Association (ISDA) day-count conventions, affect of holidays and other cash flow, and reset related parameters.

Column (3) lists the number of days between each successive floating rate payment date. For example, there are 91 days between Mar. 14, 2011 and Jun. 13, 2011. Column (4) lists a price of a final settlement value for quarterly Eurodollar futures contracts. For example, the final settlement price for a Eurodollar futures contracts on Mar. 14, 2011 is 99.635. The exchange computer system 100 may receive the price in column (4) from a market data source, such as, for example, from CME Globex®.

Column (5) lists an implied yield associated with the Eurodollar futures contracts as 100 minus the Eurodollar futures price in column (4). For example, on Mar. 14, 2011, the implied yield of the March 2011 Eurodollar futures contract is 100%−99.635%=0.365%. Also, instead of using yields based on Eurodollar futures contracts, the yields in column (5) may be based on implied forward rates related to short-term treasury rates, LIBOR rates, or other manners of providing periodic assessments of yields over time. Implied forward rates may be calculated based on the assumption of zero arbitrage opportunities in interest rate markets. For example, if the 90-day spot LIBOR rate was 1.00% and the 180-day spot Libor rate was 1.50%, then the implied forward rate for a LIBOR based money market instrument (loan or deposit) with a start date=T+90 and a termination date=T=180 ensures that the following condition holds:

[1+R(90)×(90/360)]×[1+IRF(90,180)×90/360]=[1+R(180)×180/360], or [1+1.00%×(90/360)]×[1+IRF(90,180)×90/360]=[1+1.50%×180/360].

This relationship may be rearranged to derive the following expression for the Implied forward rate:

$$Implied Forward Rate ( 90 , 180 ) = IFR ( 90 , 180 ) = [ ( 1 + R ( 180 ) \times 180 / 360 ) / ( 1 + R ( 90 ) \times 90 / 360 ) - 1 ] \times ( 360 / 90 ) , \\ or = [ ( 1 + 1.50 \% \times 180 / 360 ) / ( 1 + 1.00 \% \times 90 / 360 ) - 1 ] \times ( 360 / 90 ) = 1.9950 \% .$$

Column (6) lists a terminal value referring to a compounded return associated with quarterly Eurodollar yields. For example, investing one dollar at a yield of 0.365% on Mar. 14, 2011 results in a terminal value of $1.0009 at the end of 91 days (i.e., Jun. 13, 2011).

Column (7) lists a discount factor calculated as a reciprocal of the terminal value in column (6) (i.e., 1/terminal value). For example, the discount factor on Jun. 13, 2011 is 1/1.0009=0.9991. The discount factor may be used to discount a future value back to a present value (e.g., discount the value of a future floating rate payment back to its value on Mar. 14, 2011). Column (8) lists the quarterly floating payment calculated by reference to Eurodollar yield shown in column (5) over the number of days shown in Day Span in column (3) based on using a 360-day count convention for a year. For example, on Jun. 13, 2011, the floating payment is $922.64=([Eurodollar Yield] *[Day Span]/360)*notional amount=(0.365%*91/360)*$1,000,000.

Column (9) lists the present value of the floating rate payment calculated by multiplying the floating rate payment from column (8) by the discount factor in column (7). The exchange computer system 100 may discount the floating rate payment to its present value for purposes of calculating the quote for the FRA index futures contract. For example, on Mar. 14, 2011, the present value of a floating payment to be paid on Jun. 13, 2011 is $922.64*0.9991=$921.79. It is noted that rounding of the digits in the table slightly affects the calculations.

Column (10) lists the fixed rate payment calculated based upon $1 million notional value for a 1% coupon. In this example, fixed rate payment=notional amount*coupon value*0.25=$1,000,000*0.01*0.25=$2,500. Column (11) lists the present value of fixed rate payment calculated as fixed payment in column (10) multiplied by the discount factor in column (7). The exchange computer system 100 may discount the fixed rate payment to its present value for purposes of calculating the quote for the FRA index futures contract. Based on the information in table 200, the exchange computer system 100 may calculate a quote for the FRA index futures contract.

FIG. 2B illustrates a table for determining the value of a quote for a FRA index futures contract in accordance with example embodiments. With reference to table 200 and to equation 1 above, the exchange computer system 100 may determine the non-par value in USD by subtracting the present value of the floating payment from the present value of fixed payment. In the example of FIG. 2B, this is $921.79−$2,497.70=−$1,575.91.

The exchange computer system 100 may subsequently determine the non-par value in terms of percent of par by dividing the non-par value in USD by the notional value. In the example of FIG. 2A, this is −$1,575.91/$1,000,000=−0.1576%. The exchange computer system 100 may provide a quote for the FRA index futures contract as 100% of par plus the non-par value in percentage terms. This convention provides a quote for the FRA index futures contact that is a positive, and not a negative, number. For example the exchange computer system 100 may determine the quote by adding 100% to the non-par value in percentage terms. In the example of FIG. 2B, this is 100%+(−0.1576%)=99.8424%. The quote is as of the final settlement date, which in the example of FIG. 2A is Mar. 14, 2011. The quote may vary over time up the final settlement date.

The quote is in excess of 100% of par when the present value of the floating rate payment exceeds the present value of the fixed rate payment. The quote is less than 100% of par when the present value of the floating rate payment is less than the present value of the fixed rate payment. The quote may permit traders to assess the value of the FRA index futures contract and provide liquidity to the FRA futures contract by its association with a sufficiently liquid financial instrument.

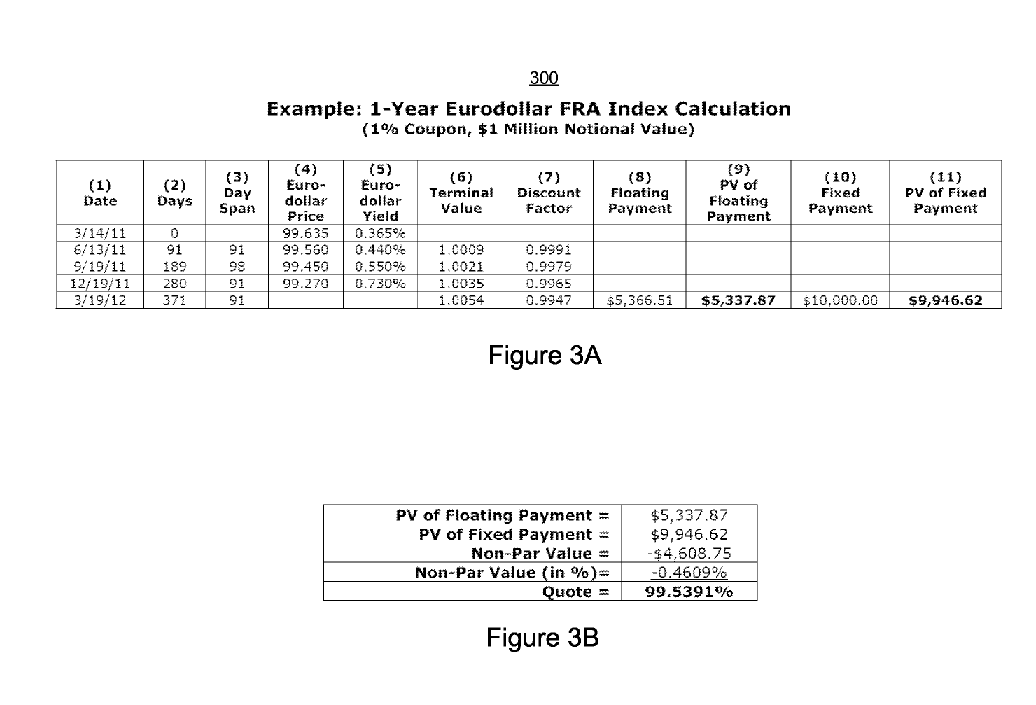

FIG. 3A illustrates a table corresponding to a calculation for a 1 year Eurodollar FRA Index futures contract having a 1% coupon and $1 million Notional value.

Starting on the left, column (1) of table 300 includes final settlement dates of standard quarterly Eurodollar futures contracts. The first date in this calculation of Mar. 14, 2011 represents a final settlement date for the 1 year Eurodollar FRA index futures contract. Column (2) lists a day-count between the first date (i.e., in this case Mar. 14, 2011) and any subsequent quarterly date. For example, the FRA index futures contract may have standard terms specifying use of International Swaps and Derivatives Association (ISDA) day-count conventions, effect of holidays and other cash flow, and reset related parameters.

Column (3) lists the number of days between each successive floating rate payment date. For example, there are 91 days between Mar. 14, 2011 and Jun. 13, 2011, 98 days between Jun. 13, 2011 and Sep. 19, 2011, and so forth. Column (4) lists a price of a final settlement value for quarterly Eurodollar futures contracts. For example, the price for a Eurodollar futures contracts maturing on Mar. 14, 2011 is 99.635, the daily settlement price for a Eurodollar futures contracts maturing on Jun. 13, 2011 is 99.560, and so forth. The exchange computer system 100 may receive the prices in column (4) from a market data source, such as, for example, from CME Globex®.

Column (5) lists implied yields associated with the Eurodollar futures contracts as 100 minus the Eurodollar Futures price in column (4). For example, on Mar. 14, 2011, the implied yield of the March 2011 Eurodollar futures contract is 100%−99.635%=0.365%. Also, instead of using implied yields based on Eurodollar futures contracts, the implied yields in column (5) may be based on implied forward rates related to treasury rates, LIBOR rates, or other manners of providing periodic assessments of yields over time.

Column (6) lists a terminal value referring to a compounded return associated with quarterly Eurodollar yields. For example, investing one dollar at a yield of 0.365% on Mar. 14, 2011 results in a terminal value of $1.0009 at the end of 91 days (i.e., Jun. 13, 2011). The terminal values in column (6) assume that returns are reinvested from quarter to quarter. Continuing the example, investing $1.0009 at 0.440% yield for 98 days results in a terminal value of $1.0021 at the end of the next floating rate period, and so forth.

Column (7) lists a discount factor calculated as a reciprocal of the terminal value in column (6) (i.e., 1/terminal value). For example, the discount factor on Jun. 13, 2011 is 1/1.0009=0.9991. The discount factor may be used to discount a current value back to a present value (e.g., discount value of a floating rate payment back to its value on Mar. 14, 2011). Column (8) lists the single floating payment calculated by reference to Eurodollar yield shown in column (5) over the number of days shown in Day Span in column (3) based on using a 360-day count convention for a year.

Column (9) lists the present value of the single floating rate payment calculated by multiplying the floating payment from column (8) by the last discount factor listed in column (7) (i.e., 0.9947). The exchange computer system 100 may discount the floating rate payment to its present value for purposes of calculating the quote for the FRA index futures contract. For example, on Mar. 14, 2011, the present value of a floating payment to be paid on Jun. 13, 2011 is $5,366.51*0.9947=$5,337.87. It is noted that rounding of the digits in the table slightly affects the calculations.

Column (10) lists the fixed rate payment calculated based upon $1 million notional value for a 1% coupon. In this example, fixed rate payment=notional amount*coupon value=$1,000,000*0.01=$10,000. Column (11) lists the present value of single fixed rate payment calculated as fixed payment in column (10) multiplied by the last discount factor in column (7) (i.e., 0.9947). The exchange computer system 100 may discount the fixed rate payment to its present value for purposes of calculating the quote for the FRA index futures contract. Based on the information in table 300, the exchange computer system 100 may calculate a quote for the FRA index futures contract.

FIG. 3B illustrates a table for determining the value of a quote for a FRA index futures contract in accordance with example embodiments. With reference to table 300 and to equation 1 above, the exchange computer system 100 may determine the non-par value in USD by subtracting the present value of floating payment from the present value of fixed payment. In the example of FIG. 3A, this is $5,337.87−$9,946.62=−$4,608.75. Other currencies instead of USD may also be used.

The exchange computer system 100 may subsequently determine the non-par value in terms of percent of par by dividing the non-par value in USD by the notional value. In the example of FIG. 3B, this is −$4,608.75/$1,000,000=−0.4609%. The exchange computer system 100 may provide a quote for the FRA index futures contract as 100% of par plus the non-par value in percentage terms. This convention provides a quote for the FRA index futures contact that is a positive, and not a negative, number. For example the exchange computer system 100 may determine the quote by adding 100% to the non-par value in percentage terms. In the example of FIG. 3B, this is 100%+(−0.4609%)=99.5391%. The quote is as of the final settlement date, which in the example of FIG. 3A is Mar. 14, 2011. The quote may vary over time up the final settlement date (i.e., up to Mar. 14, 2011).

The quote is in excess of 100% of par when the present value of the single floating rate payment exceeds the present value of the single fixed rate payment. The quote is less than 100% of par when the present value of the single floating rate payment is less than the present value of the single fixed rate payment. The quote may permit traders to assess the value of the FRA index futures contract and provide liquidity of the FRA index futures contract by its association with a sufficiently liquid financial instrument.

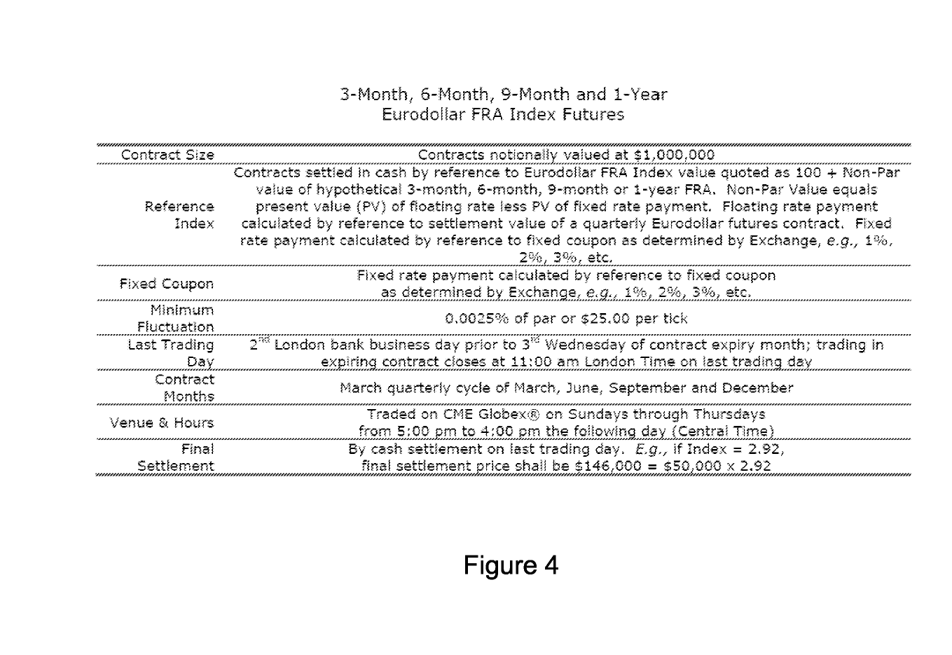

FIG. 4 illustrates example standardized terms of 3-month, 6-month, 9-month and 1-year Eurodollar FRA Index Futures contracts. Standardized terms may provide for a contract size, a reference index, a fixed coupon, venue & hours, minimum fluctuation, last trading day, contract months, and final settlement. In an example, the FRA index futures contract may specify a minimum allowable price fluctuation or tick size (e.g., 0.0025% of par or $25.00 per tick). It is noted that the standard terms provided in FIG. 4 are examples. Other standardized terms may also be used.

The exchange computer system 100 or a computer of another entity may act as a price dissemination device for the FRA index futures contract. When acting as a price dissemination, the exchange computer system 100 may communicate via a network (e.g., Internet 126) a quote for the FRA index futures contract to computers of market makers or traders to solicit bids and offers. The exchange computer system 100 may process order messages with bids and/or offers received from computers of one or more traders received in response to the quote. A match engine module 106 of the exchange computer system 100 may match bids and offers that have a common quantity and price to execute a trade for the FRA index futures contract. Thus, multiple bids may compete against one another, and multiple offers may compete against one another to execute a trade for the FRA index futures contract. Traders may use conventional types of orders (e.g., market orders, limit orders, etc.) when submitting bids and offers.

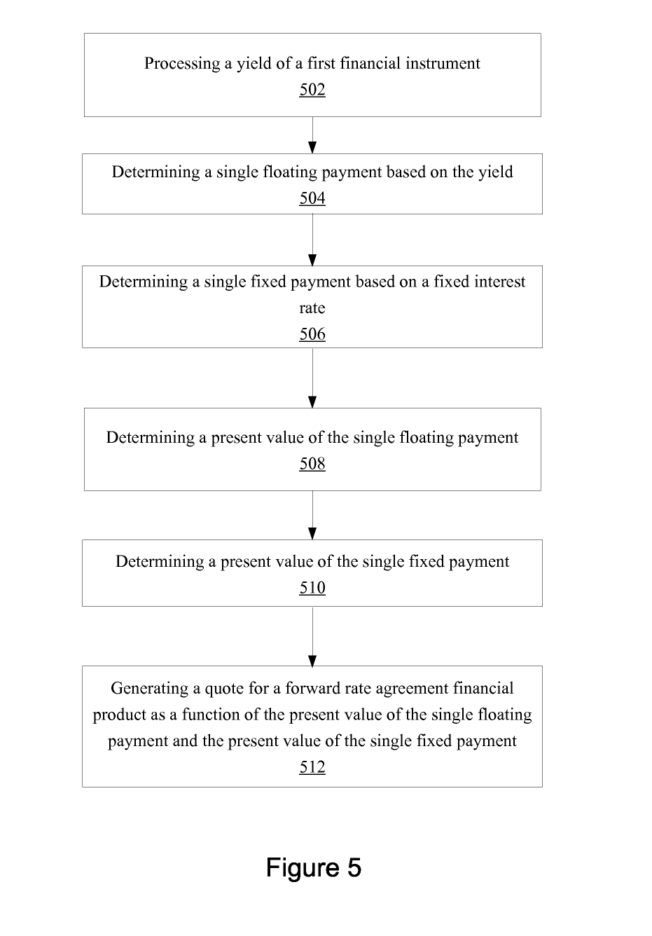

FIG. 5 illustrates an example flow diagram of a method for generating a quote for a FRA index financial product. The method may be implemented on a computer, such as, for example, exchange computer system 100. The blocks shown in FIG. 5 may be rearranged, some blocks may be removed, and additional blocks may be added. The flow diagram may begin at block 502.

In block 502, the method may include processing a yield of a first financial instrument. For example, the exchange computer system 100 may receive market data about a yield for 3-month Eurodollar futures contracts. The exchange computer system 100 may also calculate implied forward rates to determine the yield, may also use a yield on a U.S. treasury, or may use a yield associated with other sufficiently liquid financial instrument.

In block 504, the method may include determining a single floating rate payment based on the yield. For example, the exchange computer system 100 may calculate a floating rate payment as described above with reference to column (8) of FIG. 2A.

In block 506, the method may include determining a single fixed payment based on a fixed interest rate. For example, the exchange computer system 100 may calculate a single fixed rate payment as described above with reference to column (10) of FIG. 2A.

In block 508, the method may include determining a present value of the single floating payment. For example, the exchange computer system 100 may calculate the present value of the single floating rate payment as described above with reference to column (9) of FIG. 2A.

In block 510, the method may include determining a present value of the single fixed payment. For example, the exchange computer system 100 may calculate the present value of the single fixed rate payment as described above with reference to column (11) of FIG. 2A.

In block 512, the method may include generating a quote for a FRA financial product as a function of the present value of the single floating payment and the present value of the single fixed payment. For example, the exchange computer system 100 may determine a quote of a FRA index futures contract, as described above with reference to FIG. 2B. The method may then end, or may return to any of the above blocks. Also, the operations described with reference to each may be performed multiple times before proceeding to a different block.

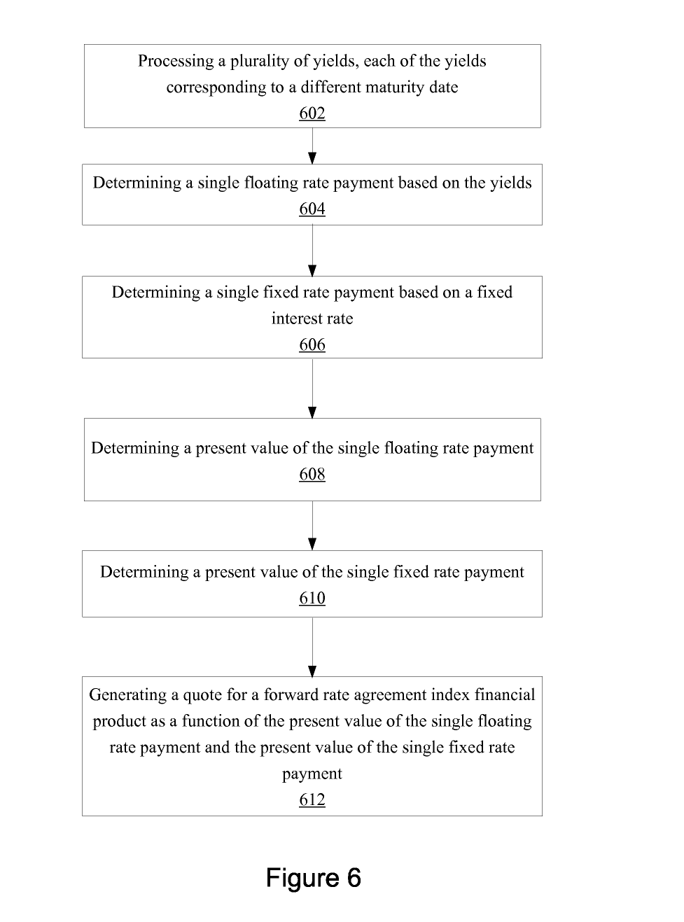

FIG. 6 illustrates an example flow diagram of a method for generating a quote for a FRA index financial product. The method may be implemented on a computer, such as, for example, exchange computer system 100. The blocks shown in FIG. 6 may be rearranged, some blocks may be removed, and additional blocks may be added. The flow diagram may begin at block 602.

In block 602, the method may include processing a plurality of yields, each of the yields corresponding to a different maturity date. For example, the exchange computer system 100 may receive market data about a yield for a 3-month Eurodollar futures contract, a 6-month Eurodollar futures contract, a 9-month Eurodollar futures contract, and a 12-month Eurodollar futures contract. The exchange computer system 100 may also calculate implied forward rates to determine the yields, may also use yields on U.S. treasuries maturing at different time intervals, or may use other sufficiently liquid financial instruments maturing at different time intervals to determine the yields.

In block 604, the method may include determining a single floating rate payment based on the yields. For example, the exchange computer system 100 may calculate a floating rate payment as described above with reference to column (8) of FIG. 3A.

In block 606, the method may include determining a single fixed rate payment based on a fixed interest rate. For example, the exchange computer system 100 may calculate fixed rate payment as described above with reference to column (10) of FIG. 3A.

In block 608, the method may include determining a present value of the single floating rate payment. For example, the exchange computer system 100 may calculate the present value of the single floating rate payment as described above with reference to column (9) of FIG. 3A.

In block 610, the method may include determining a present value of the single fixed payment. For example, the exchange computer system 100 may calculate the present value of the single fixed rate payment as described above with reference to column (11) of FIG. 3A.

In block 612, the method may include generating a quote for a FRA financial product as a function of the present value of the single floating payment and the present value of the single fixed payment. For example, the exchange computer system 100 may determine a quote of a FRA index futures contract, as described above with reference to FIG. 3B. The method may then end, or may return to any of the above blocks. Also, the operations described with reference to each may be performed multiple times before proceeding to a different block.

It is noted that derivatives besides FRAs may also be used when creating the FRA index futures contract, including, for example, credit default or other swaps, options, and futures. The example embodiments are contemplated to be useful in connection with any derivative, by which is contemplated any instrument whose value depends on an underlying value.

The present disclosure has been described herein with reference to specific exemplary embodiments thereof. It will be apparent to those skilled in the art that a person understanding this disclosure may conceive of changes or other embodiments or variations, which utilize the principles of this disclosure without departing from the broader spirit and scope of the disclosure as set forth in the appended claims.

1. (canceled)

2. A method comprising:
receiving, by a computer system and for each of one or more dates, a current settlement value of a liquid futures contract maturing on that date;
calculating, by the computer system, a yield corresponding to each of the one or more dates, each of the yields based on the current settlement value of the futures contract maturing on the date corresponding to the yield;
determining, by the computer system, a floating payment corresponding to a future date after the latest of the one or more dates, the floating payment being based on the one or more yields;
determining, by the computer system, a fixed payment based on a fixed interest rate;
determining, by the computer system, a terminal value corresponding to the future date and representing a return based at least in part on the yield corresponding to the one of the one or more dates immediately preceding the future date;
determining, by the computer system, a discount factor corresponding to the future date, the discount factor being an inverse of the terminal value corresponding to the future date;
determining, by the computer system, a present value for the floating payment, the floating payment present value representing the product of the floating payment and the discount factor corresponding to the future date;
determining, by the computer system, a present value for the fixed payment, the fixed payment present value representing the product of the fixed payment and the discount factor corresponding to the future date;
generating, by the computer system, a quote for a forward rate agreement futures contract as a function of the present value of the floating payment and the present value of the fixed payment, wherein the forward rate agreement futures contract has standard terms and price as the only trading variable;
processing a plurality of bids and a plurality of offers for the forward rate agreement futures contract in response to the quote; and
matching at least one of the bids and at least one of the offers to execute a trade for the forward rate agreement futures contract.

3. The method of claim 2, wherein the generating comprises subtracting one of the present value of the floating payment and the present value of the fixed payment from the other of the present value of the floating payment and the present value of the fixed payment to obtain a subtraction result, and then subtracting the subtraction result from a fixed value.

4. The method of claim 2, wherein the receiving comprises receiving settlement values for Eurodollar futures contracts maturing on each of the one or more dates.

5. A computer readable medium storing computer executable instructions that, when executed, cause an apparatus to at least perform:
receiving, for each of one or more dates, a current settlement value of a liquid futures contract maturing on that date;
calculating a yield corresponding to each of the one or more dates, each of the yields based on the current settlement value of the futures contract maturing on the date corresponding to the yield;
determining a floating payment corresponding to a future date after the latest of the one or more dates, the floating payment being based on the one or more yields;
determining a fixed payment based on a fixed interest rate;
determining a terminal value corresponding to the future date and representing a return based at least in part on the yield corresponding to the one of the one or more dates immediately preceding the future date;
determining a discount factor corresponding to the future date, the discount factor being an inverse of the terminal value corresponding to the future date;
determining a present value for the floating payment, the floating payment present value representing the product of the floating payment and the discount factor corresponding to the future date;
determining a present value for the fixed payment, the fixed payment present value representing the product of the fixed payment and the discount factor corresponding to the future date;
generating a quote for a forward rate agreement futures contract as a function of the present value of the floating payment and the present value of the fixed payment, wherein the forward rate agreement futures contract has standard terms and price as the only trading variable;
processing a plurality of bids and a plurality of offers for the forward rate agreement futures contract in response to the quote; and
matching at least one of the bids and at least one of the offers to execute a trade for the forward rate agreement futures contract.

6. The computer readable medium of claim 5, wherein the generating comprises subtracting one of the present value of the floating payment and the present value of the fixed payment from the other of the present value of the floating payment and the present value of the fixed payment to obtain a subtraction result, and then subtracting the subtraction result from a fixed value.

7. The computer readable medium of claim 5, wherein the receiving comprises receiving settlement values for Eurodollar futures contracts maturing on each of the one or more dates.

8. An apparatus comprising:
a processor; and
a memory storing computer executable instructions that, when executed, cause the apparatus to at least perform:
receiving, for each of one or more dates, a current settlement value of a liquid futures contract maturing on that date,
calculating a yield corresponding to each of the one or more dates, each of the yields based on the current settlement value of the futures contract maturing on the date corresponding to the yield,
determining a floating payment corresponding to a future date after the latest of the one or more dates, the floating payment being based on the one or more yields,
determining a fixed payment based on a fixed interest rate,
determining a terminal value corresponding to the future date and representing a return based at least in part on the yield corresponding to the one of the one or more dates immediately preceding the future date,
determining a discount factor corresponding to the future date, the discount factor being an inverse of the terminal value corresponding to the future date, determining a present value for the floating payment, the floating payment present value representing the product of the floating payment and the discount factor corresponding to the future date,
determining a present value for the fixed payment, the fixed payment present value representing the product of the fixed payment and the discount factor corresponding to the future date,
generating a quote for a forward rate agreement futures contract as a function of the present value of the floating payment and the present value of the fixed payment, wherein the forward rate agreement futures contract has standard terms and price as the only trading variable,
processing a plurality of bids and a plurality of offers for the forward rate agreement futures contract in response to the quote, and
matching at least one of the bids and at least one of the offers to execute a trade for the forward rate agreement futures contract.

9. The apparatus of claim 8, wherein the generating comprises subtracting one of the present value of the floating payment and the present value of the fixed payment from the other of the present value of the floating payment and the present value of the fixed payment to obtain a subtraction result, and then subtracting the subtraction result from a fixed value.

10. The apparatus of claim 8, wherein the receiving comprises receiving settlement values for Eurodollar futures contracts maturing on each of the one or more dates.
